(19) United States
(12) Patent Application Publication
(10) Pub. No.: US 2022/0066052 A1
(43) Pub. Date: Mar. 3, 2022

(54) Electronic Control System for Position Determination, Method and Utilization

(71) Applicant: Continental Automotive Systems, Inc., Auburn Hills, MI (US)

(72) Inventor: Ulrich Stählin, Oakland Township, MI (US)

(73) Assignee: Continental Automotive Systems, Inc., Auburn Hills, MI (US)

(21) Appl. No.: 17/008,125

(22) Filed: Aug. 31, 2020

(51) Int. Cl. G01S 19/33; G01S 19/37; G01S 19/39; H04W 4/48

(52) U.S. Cl. CPC G01S 19/33; H04W 4/48; G01S 19/396; G01S 19/37

(57) ABSTRACT

An electronic control system and a method for position determination utilizing a satellite navigation system having regulated self-heating is described. The system includes a computing device for data processing. The computing device is configured to use data of an information carrier for a position determination and/or for a determination of a movement velocity and/or for a determination of a current time on demand and/or as a function of a usage of the computing device and/or a temperature of the computing device.

### TECHNICAL FIELD

The present disclosure relates to an electronic control system for position determination and a corresponding method.

### BACKGROUND

In order to avoid lines which are prone to failure and resource-intensive, and due to the relatively high frequency provided, an attempt is in principle made to connect chips for processing received signals of a global satellite navigation system (GNSS), including, in particular, the electronic components needed to operate the GNSS antenna as well as computing device(s) for processing the received data, as spatially close as possible or respectively with as short as possible a signal transmission path to the antenna, so that faults or respectively line losses in said region of the transmission route can be minimized. The local proximity of the GNSS chip can, however, result in the latter being exposed to a non-compatible temperature. Therefore, it is desirable to overcome the aforementioned problems and, nevertheless, makes possible the striven-for short connection of the GNSS chipset to the antenna.

### SUMMARY

One aspect of the disclosure relates to an electronic control system for position determination utilizing a satellite navigation system. The system includes a computing device for data processing, where the computing device is configured to use data of an information medium/carrier, which are in particular suitable for determining a position, for a position determination and/or for a determination of a movement velocity and/or for a determination of a current time on demand and/or as a function of a usage of the computing device and/or a temperature of the computing device.

A computing device can be any device which is designed in order to process at least one of the indicated signals. For example, the computing device can be a processor, for example an ASIC, a FPGA, a digital signal processor, a central processing unit (CPU), a multi-purpose processor (MPP) or similar.

In some implementations, the electronic control system furthermore includes suitable functional components for receiving and processing GNSS signals such as, for example, at least one antenna and at least one receiver for receiving GNSS signals.

The self-heating of the electronic control system for position determination or respectively of the underlying computing device and, consequently, the temperature development are, in principle, substantially determined by the currently deployed computational resources or respectively the currently deployed computational cost for the position determination. Consequently, the idea is to achieve the decrease in the self-heating of the GNSS chipset during operation by adapting the used information carriers which can, for example, be used or respectively are suitable for position determination. The resulting decrease in the computational resources, which would otherwise be used for calculating the position, velocity or time, attained due to the decreased workload results in a lower self-heating and, thus, temperature of the computing device. Consequently, information carriers are dynamically consulted or respectively omitted in order to determine the respective values to be established, in particular position, velocity and/or time. The self-heating of the electronic control system can therefore be embodied in a regulated manner.

Thus, a short connection of the GNSS chipset to the antenna may be made possible without, for example, exposing the high-frequency components to a temperature which is not compatible for these. For example, an entire disconnection of the electronic control system can consequently be avoided. Moreover, increased costs for possible cooling measures for achieving a comparable effect are avoided.

The components of the electronic control system may be enclosed by a joint housing, where the temperature inside the housing can be assumed to be substantially the same so that the temperature of the computing device can be assumed to correspond to the temperature inside the housing. In addition or alternatively, the temperature value can be established at a or respectively for a location or respectively a space which is relevant to the disclosure.

In some implementations, the information carrier is designed as a signal of one or more satellite navigation system(s) and/or as a signal of a sensor and/or as a signal of a vehicle-to-X communication apparatus.

In some examples, signals of different frequencies of the satellite navigation system or satellite navigation systems can be used as separate information carriers.

The electronic control system may be configured to receive signals of at least two different satellite navigation systems, wherein each of the signals may be used as a separate information carrier.

In some implementations, the electronic control system is configured to adapt a scanning rate (also a sampling rate) of the data of a respective information medium on demand and/or as a function of a usage of the computing device and/or as a function of a temperature of the computing device.

Modern GNSS chipsets usually support a multiplicity of existing satellite systems such as, for example, GPS, Galileo, GLONASS and/or BeiDou and frequently, in addition, different frequencies such as e.g. L1, L2 and/or L5. Furthermore, a fusion with vehicle dynamics information which is usually detected by sensors can be provided for dead reckoning. The prerequisite for processing the workload as a consequence of the considerable quantity of received information for determining position, velocity and time (PVT) is a correspondingly designed computational performance of the chip. Accordingly, signals of different satellite navigation systems, signals of different frequencies of at least one of the different satellite navigation systems and/or signals, which have been established using at least one sensor, can be expediently used as information carriers on demand and/or as a function of a usage of the computing device and/or as a function of a temperature of the computing device. Exactly the same applies to the respective scanning rates of the respective indicated information carriers which can likewise be configured to be alterable on demand and/or as a function of a usage of the computing device and/or as a function of a temperature of the computing device.

The underlying concept is to control the workload and the consequential self-heating of the GNSS chip in that the information of the various indicated information carriers, that is to say for example of various satellite systems and/or of different frequencies of at least one of the satellite systems and/or of movement dynamic sensors, is used for the PVT determination on demand and/or as a function of a usage or respectively workload of the computing device and/or of a temperature of the computing device. As a result, the striven-for short connection of the GNSS chipset to the antenna can in particular be made possible, without having to provide resource-intensive cooling measures and without obtaining a substantial restriction in the functionality. The usage of the computing device or respectively temperature can be determined with means and/or methods suitable for this purpose. For example, it can therefore be provided that all of the data available via the various information carriers are used for the PVT determination if the conditions make this possible.

In some examples, the electronic control system is configured to additionally not use the data of at least one information medium if a confidence value for describing a confidence region (confidence interval) of an established position and/or of an established velocity and/or of an established current time reaches or falls short of a threshold. The electronic control system may be configured to establish the confidence value regarding the established position and/or the established velocity and/or the established time. The data of the used information carriers may be key for the determination of the confidence value. The underlying idea is that if the accuracy of the position determination, the velocity determination and/or the time determination, measured with the aid of the established confidence value, is equal to the threshold or below the threshold, that is to say if a high accuracy of the determination is provided, data of one or more of the usable information carriers are not used for a subsequent position determination, velocity determination and/or time determination in order to avoid unnecessary resource implications and, thus, unnecessary self-heating. Unnecessary in this sense means, for example, that a relatively low further increase in the accuracy requires high additional resource implications. Accordingly, the electronic control system may be configured to use the data of an information medium on demand if a confidence value for describing a confidence region of an established position and/or of an established movement velocity and/or of an established current time reaches or exceeds the threshold. If the result of the calculations should worsen again, which can be ascertained with the aid of the confidence value, data of one or more information carriers can consequently be used again. In order to form a hysteresis, different thresholds may also be provided as a function of the accuracy development direction, in order to avoid a permanent switching over between the using of data of an information medium and the non-using of the data of the information medium. However, care should be taken that predefined limits, for example, of the temperature and usage of the computing device are not exceeded, where the described procedure regarding the consideration of the confidence values can predefine a sequence of which information carrier is used or is not used.

In some implementations, the electronic control system is configured to carry out the selection of at least one information medium which is not to be used as a function of the confidence value of the data of the information carrier compared with the confidence values of the data of the further information carriers. For example, an information carrier having a poor or respectively the poorest confidence value compared with the further information carriers can be selected and is initially no longer used for the calculation. As a result, the negative impact on the total accuracy can be left relatively low. The data of an information medium are, in principle, not used if the confidence value of the data exceeds a limit. As a result, an unintended deterioration in the total accuracy is avoided when using the data of a relevant information medium. With further consideration of the limits for the temperature and/or computing usage of the computing device, an information carrier having the poorest confidence value is no longer used, for example, in the event of at least one of the limits regarding this being exceeded, where in the event that at least one of the limits is not fallen short of hereinafter, for example after a predefined time, a next information carrier having the second-poorest confidence value is no longer used. Accordingly, a sequence of the information carriers can be provided with the aid of the confidence values.

In some implementations, a grouping of the information carriers is provided in accordance with the accuracy requirements and/or confidence requirements thereof, where the data of the information carriers of a group provided in such a way are used jointly or are not used. The data of a group of information carriers provided in such a way can therefore be used in a grouped manner, or not used, on demand and/or as a function of the usage of the computing unit and/or as a function of a temperature of the computing device. The preceding explanations regarding the advantages when using or respectively not using information carriers as a function of the confidence value thereof can be exploited in an increased manner since, consecutive to the grouping of a multiplicity of information carriers, an increased effect in terms of the workload and/or temperature of the computing device is produced.

In some implementations, the electronic control system is configured to use data of all of the usable information carriers for the position determination, velocity determination and/or time determination if the temperature of the computing device is equal to or below a first temperature threshold and/or the usage of the computing device is equal to or below a usage threshold. In some examples, the electronic control system is configured to not use the data of all of the usable information carriers for the position determination, velocity determination and/or time determination if the temperature of the computing device is equal to or above a second temperature threshold and/or the usage of the computing device is equal to or below a usage threshold. The first and the second temperature threshold may have different values in order to form a hysteresis. Alternatively, the first and the second temperature threshold may also have consistent values.

In some implementations, the electronic control system is configured to establish the temperature by a temperature detecting device and/or indirectly via a power consumption and/or a current consumption of at least a part of the electronic components of the electronic control system. For example, a temperature determination can be carried out using a calculated power consumption, on the basis of a voltage and of a current consumption of the computing device and/or of one or more components of the electronic control system if it can be illustrated that there is a link. The quantitative value or quantitative values is/are expediently linked in a way that can be illustrated to the temperature at the relevant location or respectively in the relevant space. To this end, the electronic control system has suitable sensors such as, for example, a current sensor and/or a voltage sensor and/or power consumption meter.

In some implementations, the electronic control system is configured to execute a multiplicity of application modules in order to process the position and/or the velocity and/or the current time, where a grouping of the application modules is provided in such a way that application modules which have consistent accuracy requirements and/or confidence requirements of the provided information, position and/or the velocity and/or the current time, are allocated to a joint group, where the application modules are executed on demand and/or as a function of a usage of the computing device or of a further computing device executing the application modules, and/or as a function of a temperature of the computing device or of the further computing device.

In some examples, it can be provided that the execution of all of the application modules of a group of application modules is terminated if the temperature of the computing device or of the further computing device is equal to or above a third temperature threshold and/or the usage of the computing device or of the further computing device is equal to or below a third usage threshold. The third temperature threshold may be different from the first and/or second temperature threshold or can at least be identical to one of the indicated temperature thresholds. The third usage threshold may be different from the first and/or second usage threshold or at least identical to one of the indicated thresholds of usage. It can also be provided that a group merely includes one application module.

In some implementations, the electronic control apparatus is configured to terminate the execution of a group of application modules starting with the group, the application modules of which have the highest accuracy requirements and/or confidence requirements of the provided information. As a result, the execution of the application modules and corresponding computational load may be advantageously gradually disconnected. The reverse case of gradually switching on the modules in the event of the thresholds accordingly being fallen short off can be configured in exactly the same way, starting with the last disconnected group.

Processing the position and/or the velocity and/or the current time is understood to be utilizing the information regarding this for application modules harnessing said information. The application modules can be executed by the computing device or by a further computing device of the electronic control apparatus. Consequently, not only can the information carriers, that is to say the inputs, be provided in a grouped manner, but also the consumers of the information can be grouped or respectively clustered. As a result, the necessary accuracy to be achieved can be gradually reduced in order to comply with the temperature or respectively usage requirements of the computing device.

In some implementations, the electronic control system includes a wireless communication apparatus for mobile communication and/or a communication apparatus for vehicle-to-X communication. The communication apparatus for mobile communication and/or the communication apparatus for vehicle-to-X communication is/are enclosed by a joint housing having the GNSS chipset. Chipsets, for example for mobile communication, including cellular-V2x (C-V2X), are frequently designed for merely relatively moderate temperature ranges. The electronic control system also makes possible, for example, the enclosure in a joint housing. Especially embodied cooling measures are not necessarily required.

Another aspect of the disclosure, the disclosure further relates to the utilization of the electronic control system in a vehicle.

The vehicle may be a motor vehicle, such as a car, a truck, a motorcycle, an electric motor vehicle or a hybrid motor vehicle, a watercraft or an aircraft. Another aspect of the disclosure provides a method for position determination utilizing a satellite navigation system. The method includes the steps of receiving data of an information medium by a computing device for data processing; and using the data of the information medium for the position determination, a determination of a movement velocity and/or a determination of a current time. The data are evaluated on demand and/or as a function of a usage of the computing device and/or as a function of a temperature of the computing device.

Further implementations of the method arise during the execution of the method from the implementations of the electronic control system which have already been explained.

In some implementations of the indicated electronic control system, the system has a data memory. The indicated method is stored in the form of a computer program in the data memory and the computing device is provided to execute the method if the computer program is loaded from the data memory into the computing device.

Another aspect of the disclosure provides a computer program that includes program code means in order to perform all of the steps of one of the indicated methods if the computer program is executed by the electronic control system or respectively the computing device.

Yet another aspect of the disclosure provides a computer program product containing a program code which is saved on a computer-readable data memory and which, if it is executed by the computing device, performs the indicated method.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows an exemplary electronic control system; and

FIG. 2 shows an exemplary method for position determination utilizing a satellite navigation system.

Like reference symbols in the various drawings indicate like elements.

### DETAILED DESCRIPTION

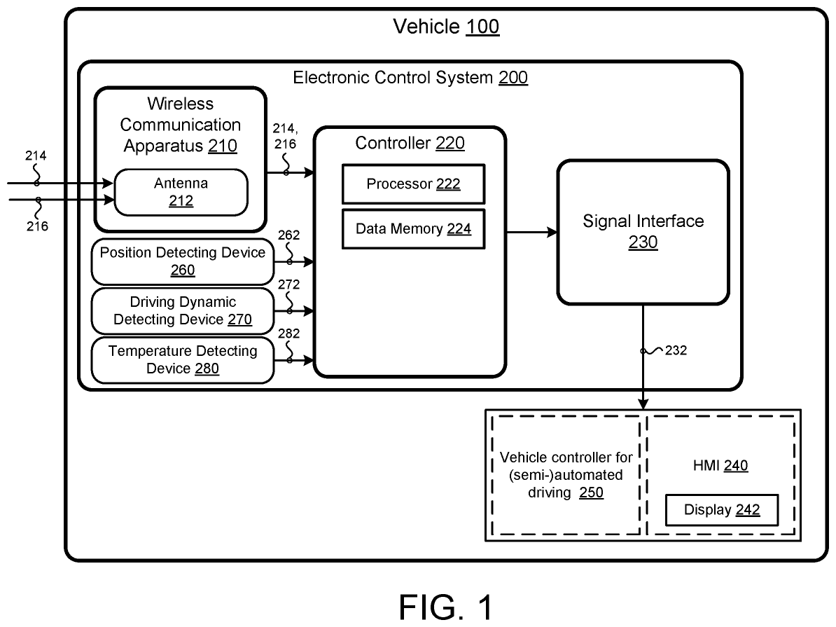

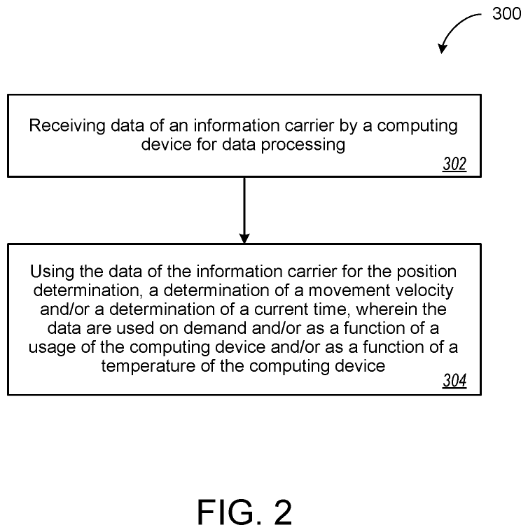

FIG. 1 shows an exemplary electronic control system 200 in a vehicle 100, the control system 200 for position determination utilizing a satellite navigation system including a controller 220 for data processing with a processor 222 and a data memory 224. The method, as shown by way of example with reference to FIG. 2, is stored in the form of a computer program in the data memory 224 and the processor 222 is provided to execute the method if the computer program is loaded from the data memory 224 into the processor 222.

The electronic control system 200 for position determination utilizing a satellite navigation system includes, in some examples, a position detecting device 260 which can provide the controller 220 with corresponding position information 262.

The electronic control system 200 can furthermore include a communication apparatus 210 having at least one antenna 212 for receiving mobile signals 214 and/or vehicle-to-X signals 216. Information or respectively data that includes the received signals 214, 216 can be provided to the controller 220.

The electronic control system 200 can furthermore include a driving dynamics detecting device 270 for detecting driving dynamics information 272, which may be applied to dead reckoning within the framework of a strapdown method. The driving dynamics information 272 can likewise be provided to the controller 220.

The electronic control system 200 may furthermore include a temperature detecting device 280 for measuring the temperature of the controller or respectively processor and/or to indirectly determine the temperature via a power consumption and/or a current consumption of at least a part of the electronic components of the electronic control system 200. The temperature information 282 may be provided to the controller 220.

Incoming or detected and/or received information or data can form information carriers which are to be utilized for a position determination and/or for a determination of a velocity and/or a determination of a current time on demand and/or as a function of a usage of the computing device and/or as a function of a temperature of the computing device.

Signals of different frequencies of the satellite navigation system which are received by the position detecting device 260 may be used as separate information carriers.

In some examples, the electronic control system 200 is designed to receive signals of at least two different satellite navigation systems, e.g. GPS, GLONASS, Galileo and/or BeiDou, where each of the signals can be used as a separate information carrier.

The electronic control system 200 may be configured to adapt a scanning rate of the data of a respective information medium on demand and/or as a function of a usage of the controller 220 or respectively processor 222 and/or as a function of a temperature of the controller 220 and/or processor 222.

In some examples, the electronic control system 200 is configured to not use the data of at least one information medium if a confidence value for describing a confidence region of an established position and/or of an established velocity and/or of an established current time reaches or falls short of a threshold.

The electronic control system 200 may be designed to carry out the selection of at least one information medium which is not to be used as a function of the confidence value of the data of the information medium compared with the confidence values of the data of the further information carriers.

In some examples, the electronic control system 200 is configured to use data of all of the usable information carriers for the position determination, velocity determination and/or time determination if the temperature of the controller 220 and/or of the processor 222 is equal to or below a first temperature threshold.

The electronic control system 200 may include a signal interface 230 for outputting a signal 232 which may include, for example, the position information 262 and/or the driving dynamics information 272 of the vehicle 100 and/or the temperature information 282, to a human-machine interface (HMI) 240 and/or a vehicle controller for (semi-) automated driving 250. The HMI 240 includes, by way of example, a display 242 for displaying the received information. Accordingly, the HMI 240 can also be designed as a navigation system. The vehicle controller 250 may be configured for automated or respectively partially automated operation of the vehicle 100.

The signal 232 may also include position data fused from the position information 262 and driving dynamics information 272, which have been established by a fusion filter such as a Kalman filter. The fusion filter (not depicted) may be realized by the controller 220 or respectively may be executed by the latter.

FIG. 2 shows, in the form of a flow chart, an exemplary method 300 for position determination utilizing a satellite navigation system. At step 302, data of an information medium are received by the controller 220 or respectively the processor 222 for data processing. At step 304, the data of the information medium for the position determination, a determination of a movement velocity and/or a determination of a current time, where the data are used on demand and/or as a function of a usage of the computing device and/or as a function of a temperature of the computing device.

If in the course of the proceedings it transpires that a feature or a group of features is not absolutely necessary, then the applicant here and now seeks a wording of at least one independent claim, no longer having the feature or the group of features. This may, for example, involve a sub-combination of a claim existing as at the application date or a sub-combination of a claim existing as at the application date restricted by further features. Such claims or combinations of features, which are to be newly worded, are understood to also be covered by the disclosure of this application.

It is further pointed out that configurations, features and variants of the disclosure, which are described in the various embodiments or exemplary embodiments and/or shown in the figures, can be combined with one another as desired. Individual or multiple features are interchangeable as desired. Resulting combinations of features are understood to also be covered by the disclosure of this application.

Back references in dependent claims should not be construed as a waiver of the right to independent, objective protection for the features of the subclaims referred back to. These features can also be used in any combination with other features.

Features which are merely disclosed in the description or features which are disclosed in the description or a claim only in conjunction with other features can, in principle, be of independent inventive relevance. They can therefore also be included separately in claims to distinguish from the prior art.

It should be pointed out in general that vehicle-to-X communication means, in particular, a direct communication between vehicles and/or between vehicles and infrastructure facilities. For example, therefore, vehicle-to-vehicle communication or vehicle-to-infrastructure communication may be involved. Where communication between vehicles is referred to within the framework of this application, this can in principle, for example, take place within the framework of vehicle-to-vehicle communication, which typically takes place without the intermediary of a mobile network or a similar external infrastructure and which can therefore be distinguished from other solutions which, for example, are based on a mobile network. For example, vehicle-to-X communication can take place utilizing the standards IEEE 802.11p or IEEE 1609.4 or 4G or 5G, in particular also PC5 or sidelink. Vehicle-to-X communication can also be referred to as C2X communication or V2X communication. The sub-areas can be referred to as C2C (Car-to-Car), V2V (Vehicle-to-Vehicle) or C2I (Car-to-Infrastructure), V2I (Vehicle-to-Infrastructure). The disclosure expressly does include vehicle-to-X communication with the intermediary of, for example, a mobile network, so-called Cellular-V2X or respectively C-V2X.

A number of implementations have been described. Nevertheless, it will be understood that various modifications may be made without departing from the spirit and scope of the disclosure. Accordingly, other implementations are within the scope of the following claims.

What is claimed is:

1. An electronic control system for position determination utilizing a satellite navigation system, the electronic control system comprising:
a computing device for data processing, wherein the computing device is configured to:
receive data of an information medium; and
use the data of the information medium for at least one of:
position determination;
determination of a velocity;
determination of a current time on demand;
as a function of a usage of the computing device; or
as a function of a temperature of the computing device.

2. The electronic control system according to claim 1, wherein the information carrier is at least one of: a signal of the satellite navigation system, a signal of a sensor, or a signal of a vehicle-to-X communication apparatus.

3. The electronic control system according to claim 1, wherein signals of different frequencies of the satellite navigation system are separate information carriers.

4. The electronic control system according to claim 1, wherein the computing device receives signals of at least two different satellite navigation systems, each of the signals is a separate information carrier.

5. The electronic control system according to claim 1, wherein the computing device adapts a scanning rate of the data of a respective information carrier on demand and/or as a function of a usage of the computing device and/or as a function of a temperature of the computing device.

6. The electronic control system according to claim 1, wherein the computing device is configured to not use the data of at least one information carrier if a confidence value for describing a confidence region of an established position and/or of an established velocity and/or of an established current time reaches or falls short of a threshold.

7. The electronic control system according to claim 6, wherein the computing device is configured to select at least one information carrier which is not to be used as a function of the confidence value of the data of the information carrier compared with the confidence values of the data of the further information carriers.

8. The electronic control system according to claim 6, wherein a grouping of the information carriers is provided, wherein the data of the information carriers of a group provided in such a way are used jointly or are not used.

9. The electronic control system according to claim 8, wherein the grouping of the information carriers is provided in accordance with the accuracy requirements and/or confidence requirements thereof.

10. The electronic control system according to claim 1, wherein the computing device is configured to use data of all of the usable information carriers for the position determination, velocity determination and/or time determination if the temperature of the computing device is equal to or below a first temperature threshold and/or the usage of the computing device is equal to or below a usage threshold, and/or the electronic control system is configured to not use the data of all of the usable information carriers for the position determination, velocity determination and/or time determination if the temperature of the computing device is equal to or above a second temperature threshold and/or the usage of the computing device is equal to or below a second usage threshold.

11. The electronic control system according claim 1, wherein the computing device is configured to establish the temperature by a temperature detecting device and/or indirectly via a power consumption and/or a current consumption of at least a part of the electronic components of the electronic control system.

12. The electronic control system according to claim 1, wherein the computing device is configured to execute a multiplicity of application modules in order to process the position and/or the velocity and/or the current time, wherein a grouping of the application modules is provided in such a way that application modules which have consistent accuracy requirements and/or confidence requirements of the provided information are allocated to a joint group, wherein the application modules are executed on demand and/or as a function of a usage of the computing device or a further computing device executing the application modules, and/or as a function of a temperature of the computing device or of the further computing device.

13. The electronic control system according to claim 12, wherein the computing device is configured to terminate the execution of all of the application modules of a group of application modules if the temperature of the computing device or of the further computing device is equal to or above a third temperature threshold and/or the usage of the computing device or of the further computing device is equal to or below a third usage threshold.

14. The electronic control system according to claim 13, wherein the computing device is configured to terminate the execution of a group of application modules starting with the group, the application modules of which have the highest accuracy requirements and/or confidence requirements of the provided position and/or the velocity and/or current time.

15. The electronic control system according to claim 1 further comprising a communication apparatus for mobile communication and/or a communication apparatus for vehicle-to-X communication.

16. A method for position determination utilizing a satellite navigation system, the method comprising:
receiving data of an information carrier by a computing device for data processing; and
using the data of the information carrier for the position determination, a determination of a movement velocity and/or a determination of a current time, wherein the data are used on demand and/or as a function of a usage of the computing device and/or as a function of a temperature of the computing device.

17. The method according to claim 16, wherein the information carrier is designed as a signal of the satellite navigation system and/or as a signal of a sensor.

18. The method according to claim 16, wherein signals of different frequencies of the satellite navigation system are used as separate information carriers.

19. The method according to claim 16, wherein signals of at least two different satellite navigation systems are received, wherein each of the signals can be used as a separate information carrier.

20. The method according to claim 16, wherein a scanning rate of the data of a respective information carrier is adapted on demand and/or as a function of a usage of the computing device and/or as a function of a temperature of the computing device.

21. The method according to claim 16, wherein the data of at least one information carrier are not used if a confidence value for describing a confidence region of an established position and/or of an established velocity and/or of an established current time reaches or falls short of a threshold.

22. The method according to claim 21, wherein at least one information carrier which is not to be used is selected as a function of the confidence value of the data of the information carrier compared with the confidence values of the data of the further information carriers.

23. The method according to claim 16, wherein the data of all of the usable information carriers are used for the position determination, velocity determination and/or time determination if the temperature of the computing device is equal to or below a first temperature threshold and/or the usage of the computing device is equal to or below a usage threshold, and/or the data of all of the usable information carriers are not used for the position determination, velocity determination and/or time determination if the temperature of the computing device is equal to or above a second temperature threshold and/or the usage of the computing device is equal to or below a second usage threshold.

24. The method according to claim 16, wherein the temperature of the computing device is established by a temperature detecting device and/or by using a power consumption and/or current consumption of at least a part of electronic components of an electronic control system executing the method.
